(19) United States
(12) Patent Application Publication
(10) Pub. No.: US 2007/0241627 A1
(43) Pub. Date: Oct. 18, 2007

(54) Lubricant cooled integrated motor/compressor design

(75) Inventor: John E. Kharsa, Westville, IN (US)

Correspondence Address: CARLSON, GASKEY & OLDS, P.C., 400 WEST MAPLE ROAD, SUITE 350, BIRMINGHAM, MI, 48009, US

(73) Assignee: Sullair Corporation

(21) Appl. No.: 11/402,378

(22) Filed: Apr. 12, 2006

(51) Int. Cl. H02K 9/20; H02K 9/26; H02K 9/00

(52) U.S. Cl. 310/156.08; 310/156.22; 310/59; 310/56; 417/472; 418/203; 310/54

(57) ABSTRACT

A compressor system according to the present invention utilizes direct rotational input from a permanent magnet motor to generate compressed air. The permanent magnet motor is mounted directly to an air screw compressor. The rotational input is provided by the permanent magnet motor to the air screw compressor without a gear train. The permanent magnet motor and associated variable speed drive controls the rotational speed of the permanent magnet motor and hence the screw compressor. Differing motors may selectively mount, and provide rotational input to, the air screw compressor.

### BACKGROUND OF THE INVENTION

The present invention relates generally to a motor for an air screw compressor and, more particularly, to a permanent magnet motor rotor mounted directly to an air screw compressor rotor.

An air screw compressor includes a male and female compressor rotor supported by bearings inside a housing which rotate relative to each other to produce compressed air. Conventional air screw compressors are typically driven by a gear train which receives rotational input from an induction motor. In some applications where a variable speed drive is utilized, the air compression output is adjusted by varying the rotational speed of the motor which adjusts the compressor rotor speed.

Typically, two or four pole AC induction motors drive air screw compressors and are known for their competitive pricing, high reliability, and wide service channels. However, rising energy costs and associated government programs and rebates, have increased consumer interest in other, energy efficient options.

One such option involves utilizing premium efficiency AC induction motors in conjunction with a variable speed drive. A drawback of this design is that induction motors reach their peak efficiency at their rated speed and their efficiency drops at lower speeds, thereby compromising the level of energy savings at a part load. In addition, the cooling requirements of AC induction motors limits the minimum operating speed which may compromise the capacity turn down.

In conventional designs incorporating gear trains, the gear train communicates the rotational input from the induction motor to the air screw compressor. Operating the air screw compressor at a high efficiency requires the compressor rotors to rotate at or near an optimum tip speed. A desired tip speed is obtained by a specific selection of step-up gears or step-down gears in the gear train, thus optimizing the rotation input into the air screw.

Although there are merits to the use of gear trains, there are several penalties associated with their use. One of these penalties is the parasitic losses associated with the gear train. These losses are continuously reflected in higher power consumption throughout the life of the compressor. Furthermore, gear trains require lubrication, maintenance, and may contribute to reduced reliability. In addition, gear trains emit noise and consist of several parts, which increases cost and take up more space.

Current air screw compressor designs also typically rely on a flexible coupling, positioned between the motor and gear box, to dampen motor torque ripple and to compensate for any misalignment between the respective drive shafts of the motor and the gear box. Current flexible coupling designs include hubs, couplings and adaptors, all of which generally increase cost and size to the overall compressor package. The use of a flexible coupling between the motor and the gear box requires periodic alignment inspections and adjustments.

Therefore, there exists a need to provide a more efficient drive mechanism for an air screw compressor system.

### SUMMARY OF THE INVENTION

A compressor system according to the present invention utilizes direct rotational input from a permanent magnet motor controlled by an inverter to generate compressed air. The permanent magnet motor is mounted directly to an air screw compressor, thus becoming an integral part of the system.

The compressor system includes an air screw compressor male rotor having a shaft portion extending into the permanent magnet motor. The shaft portion is an integral portion of the air screw compressor which eliminates alignment inspections and maintenance of the shaft interface with the air screw compressor rotor.

The shaft portion of the air screw compressor male rotor attaches to a permanent magnet motor rotor. Accordingly, rotation of the permanent magnet motor rotor rotates the air screw compressor male and female rotors. There is no need for a gear train, coupling, or other associated parts in the compressor system as the permanent magnet motor provides rotational control necessary to produce compressed air. The permanent magnet motor is an AC synchronous motor with no rotor slip leading to better speed control accuracy and higher efficiency than induction type motors. The higher efficiency nature of a permanent magnet motor translates into a cooler running motor, thus improving its speed turndown capability. The permanent magnet motor and the air screw compressor system thus maintain high efficiency throughout the speed range with significant speed turndown provided by the permanent magnet motor.

Typically, a single locknut secures the first end of the shaft portion to the permanent magnet motor rotor, thus making it simple to service. If needed, the permanent magnet motor can be easily replaced by removing the end cover and unscrewing the lock nut.

The stator portion of the permanent magnet motor is of the type that may be used with either an induction or permanent magnet rotor. Consequently, the permanent magnet motor stator may be repaired by a wide variety of existing motor repair shops.

Bearings in the air screw compressor usually support the air screw compressor rotors. Because the male air screw compressor rotor attaches to the permanent magnet motor rotor, the compressor system may not include bearings in the permanent magnet motor. Instead, the air screw compressor bearings support the permanent magnet motor rotor, and the permanent magnet motor is preferably bearingless.

The on board compressor lubricant is used to cool the motor, thus keeping the design simple. The coolant circulates through the compressor system, cooling the permanent magnet motor and lubricating the air screw compressor. Preferably, the coolant that enters the permanent magnet motor is channeled to a low pressure point in the air screw compressor system. Consequently, the coolant is re-circulated through the compressor package lubrication system, where it is filtered and cooled. Vertically orienting the permanent magnet motor relative to the air screw compressor aids in the coolant flow, through the motor.

Internal seals in the motor assembly confine the coolant and aid in channeling it to certain areas. A seal is also placed at the interface between the motor stator housing and the compressor to prevent overboard leakage. The permanent magnet motor may be classified as a Totally Enclosed Liquid Cooled (TELC) motor, as the motor is hermetically sealed and isolated from the external environment. Since the motor is lubricant cooled and the male rotor extended shaft is housed in a sealed motor stator housing, a shaft seal will not be required between the motor and compressor.

Accordingly, the present invention provides a more efficient and compact drive mechanism for an air screw compressor.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows.

FIG. 1 is a schematic view of the compressor system depicting the flow of coolant through the present invention.

FIG. 2 is a cross section view of the hermetic motor and compressor system of the present invention taken along a longitudinal axis.

FIG. 3 is an exploded view of an air screw compressor system rotor.

FIG. 4 is an exploded cross section view of the coolant path through a portion of the permanent magnet motor.

FIG. 5 is a perspective view of a permanent magnet motor rotor for the motor and compressor system of the present invention.

### DETAILED DESCRIPTION OF THE PREFERRED EMBODIMENT

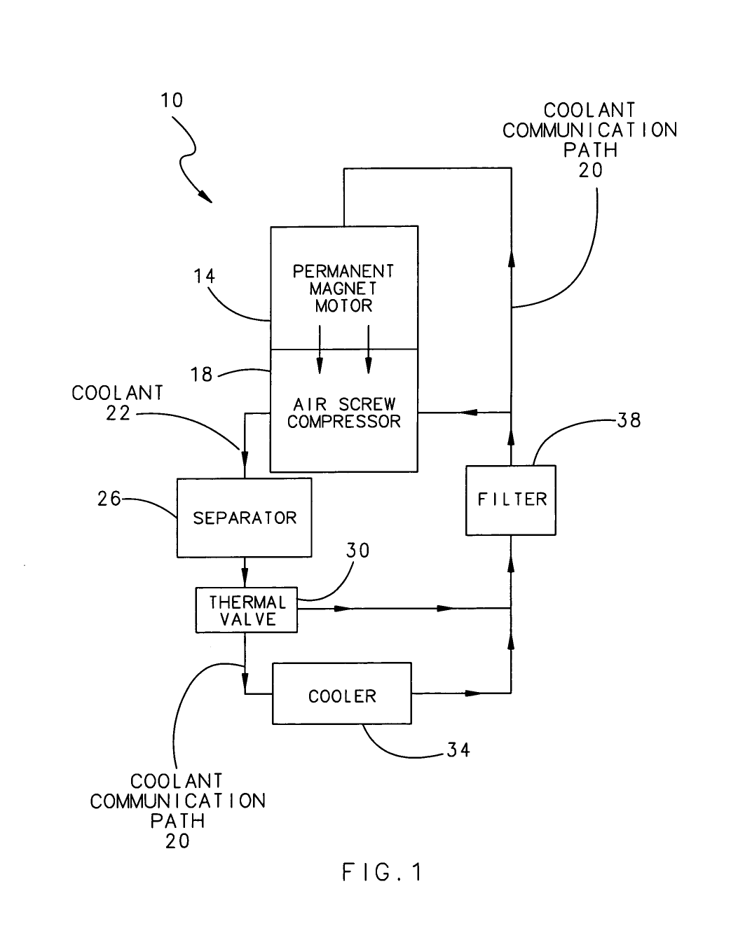

FIG. 1 illustrates a general schematic block diagram of a compressor system 10. The compressor system 10 includes a permanent magnet motor 14 mounted directly to an air screw compressor 18. The air screw compressor 18 receives a direct rotational input from the permanent magnet motor 14. The air screw compressor 18 utilizes the direct rotational input from the permanent magnet motor 14 to generate compressed air.

During air compression, the compressor system 10 produces heat which is removed from the compressor system 10 by a coolant 22. In addition, coolant 22 removes heat away from the permanent magnet motor 14 and lubricates the air screw compressor 18. The pressure differential in the system circulates coolant 22 through the compressor system 10 within a coolant communication path 20. The coolant communication path 20 circulates the coolant 22 through the air screw compressor 18 and a separator 26 which separates gas from within the coolant 22. The coolant 22 could be any lubricant suitable for compressor operations. The coolant 22 is then communicated through a thermal valve 30. In response to the temperature of the coolant 22, and the requirements of the compressor system 10, the thermal valve 30 regulates the coolant 22 temperature by selectively directing coolant 22 through a cooler 34 such as a liquid-to-air or liquid-to-water heat exchanger.

The permanent magnet motor 14 is designed to operate with a coolant 22 inlet temperature that is similar to the compressor 18 injection temperature. During operation, the temperature of the coolant 22 is regulated by the thermal valve 30 which modulates the flow of the coolant 22 to the cooler 34 to extract heat from the coolant 22. The coolant 22 communicates through a filter 38, then to the permanent magnet motor 14 and the air screw compressor 18.

In this example, the permanent magnet motor 14 is a sensorless permanent magnet motor. Accordingly, the example permanent magnet motor 14 does not require positioning sensors.

If temperature of the coolant 22 at the compressor 18 discharge is below the predetermined value, the thermal valve 30 bypasses the cooler 34 and directs all or part of the coolant 22 through a filter 38, to the permanent magnet motor 14 and the air screw compressor 18. If the temperature of the coolant 22 at the compressor 18 discharge is above the predetermined value, the thermal valve 30 directs all or part of the coolant 22 to the cooler 34. The cooler 34 lowers the temperature of the coolant 22 below the predetermined value thus regulating the compressor 18 discharge temperature. The coolant 22 then communicates through the filter 38, to the permanent magnet motor 14 and the air screw compressor 18. It should be understood that various control systems, as well as temperature responsive valves, may be utilized with the present invention to define the predetermined temperature or temperatures in response to these or other conditions.

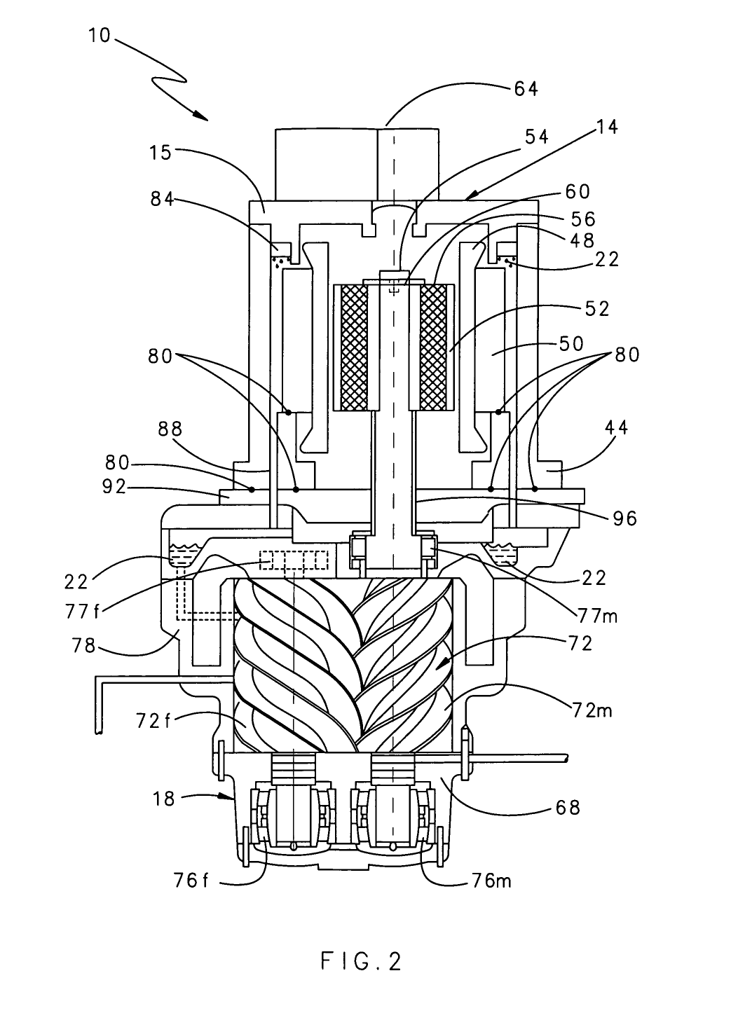

Referring to FIG. 2, the compressor system 10 includes the permanent magnet motor 14 which is controlled by a variable speed drive. A permanent magnet motor 14 includes a motor housing 44, a motor stator 48, an end cover 15, and a motor rotor 52 housing a multitude of permanent magnets 56. The motor rotor 52 is mounted to a rotor shaft portion 60 for rotation therewith about an axis 64. A fastener 54, such as a lock nut, axially secures the motor rotor 52 to the rotor shaft portion 60. The stator 48 includes coils selectively wound around laminations 50, manufactured of multi-layered steel stampings.

The air screw compressor 18 includes compressor housings 68, 78 and a compressor rotor system 72, typically having a male rotor 72m and a female rotor 72f, mounted on a respective compressor bearing, 76m, 76f. Rotating the compressor rotor system 72 produces compressed air. Inlet bearings 77m, 77f also provide support to the male rotor 72m and the female rotor 72f respectively. The rotation speed of the compressor rotor system 72 affects compression parameters such as the volume of compressed air per unit of time.

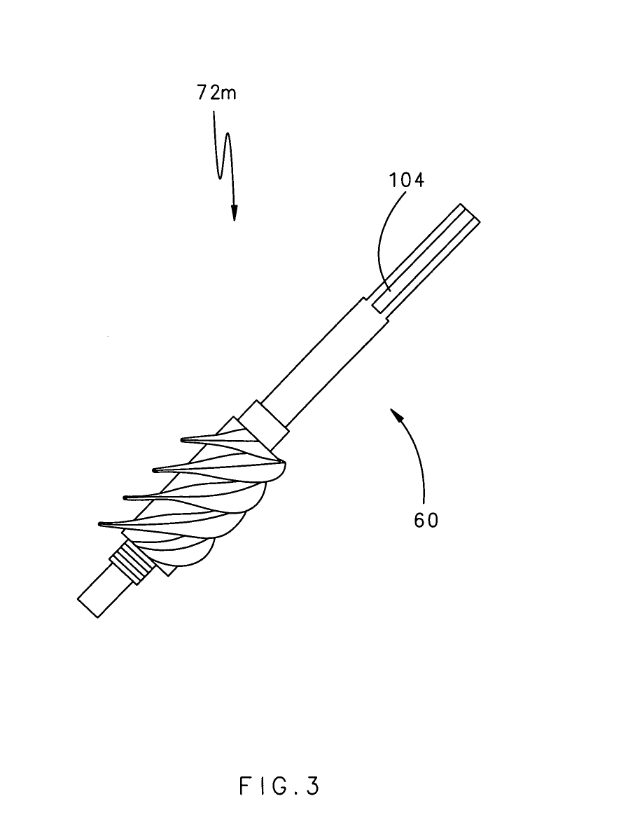

One of the compressor rotors 72m has an extended shaft portion 60, that is a homogeneous part of the male rotor 72m, as shown in FIG. 3. Thus, rotation of the rotor shaft portion 60 directly rotates the compressor rotor system 72. Adjusting the rotational speed of the rotor shaft portion 60 adjusts the rotation speed of the compressor rotors 72. Having the rotor shaft 60 as a portion of one of the compressor rotors 72m within the compressor rotor system 72 enables relatively precise control of the compressor rotor system 72. Because the motor rotor 52 directly connects to the rotor shaft portion 60, one revolution of the motor rotor 52 causes one revolution of the rotor shaft portion 60. Furthermore, because the compressor bearings 76 support the compressor rotor system 72, the permanent magnet motor 14 need not be supported upon separate bearings to support the rotor shaft portion 60 and the motor rotor 52. That is, the permanent magnet motor 14 is preferably a bearingless design since the compressor rotor system 72 supports the rotor shaft portion 60 and the motor rotor 52. Although FIG. 3 illustrates compressor rotor 72m as including the rotor shaft portion 60, it should be understood that any rotor 72m or 72f may include the rotor shaft portion 60.

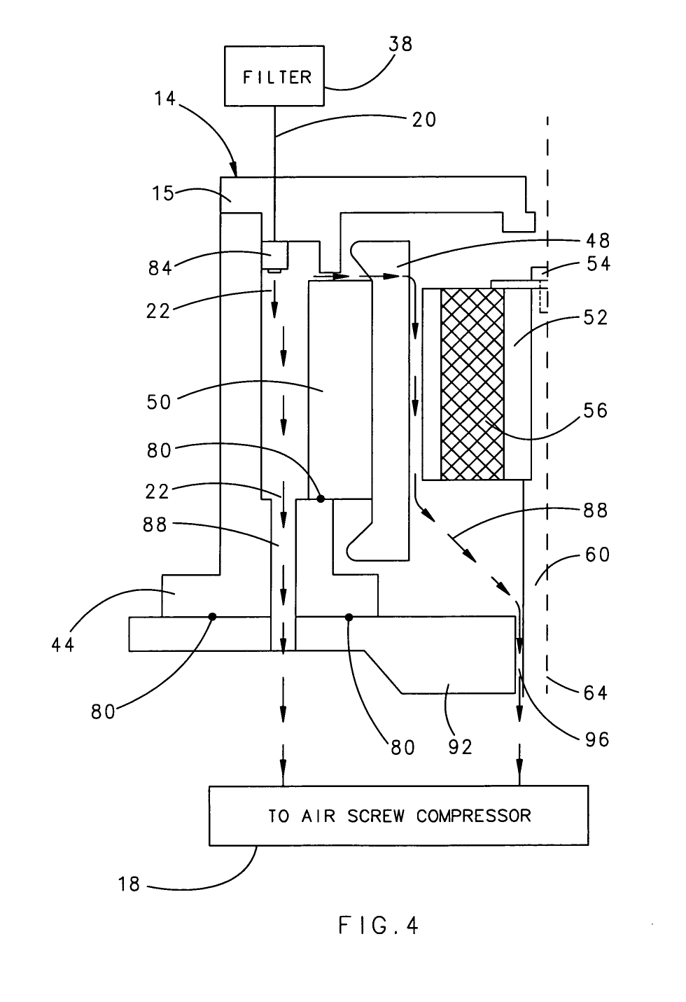

FIG. 4 illustrates the path of the coolant 22 through the permanent magnet motor 14. The coolant communication path 20 circulates coolant 22 from the filter 38 to the permanent magnet motor 14. A coolant spray manifold 84 communicates the coolant 22 to the permanent magnet motor 14. The coolant spray manifold 84 directs and distributes the coolant 22 towards an annular chamber bound by the stator lamination 50 and the motor housing 44. The coolant 22 thereby removes heat from the permanent magnet motor 14. In addition, a smaller amount of coolant 22 is introduced into the air gap between the rotor 60 and the stator 56.

A multitude of seals 80, typically O-ring seals, direct the coolant 22 within the permanent magnet motor 14, and contain the majority of the coolant 22 about the perimeter of the permanent magnet motor 14. A small amount of coolant 22 is directed through stator 48 coils and into the air gap between rotor 56 and stator 48. The seals 80 in conjunction with predetermined orifices contain the majority of the circulating coolant 22 near the perimeter of the permanent magnet motor 14 and away from the rotor shaft portion 60. Since the same coolant 22 is used throughout the compressor system 10, a shaft seal between the motor 14 and the compressor 18 will not be required. As the coolant 22 is contained within the motor housing 44, the permanent magnet motor 14 may be classified as a totally enclosed liquid cooled (TELC) motor.

The coolant 22 circulates through the permanent magnet motor 14, removing heat, and through air screw compressor 18. The permanent magnet motor 14 defines a coolant flow passage 88 which forms a segment of the coolant communication path 20 for the coolant 22. The coolant flow passage 88 directs the coolant 22 from the permanent magnet motor 14 to the air screw compressor 18 after cooling the permanent magnet motor 14.

Preferably, the permanent magnet motor 14 is mounted above the air screw compressor 18 when the compressor system 10 is mounted in a generally vertical orientation along axis 64. As the coolant 22 flows from the permanent magnet motor 14 to the air screw compressor 18 through the coolant flow passages 88, this orientation facilitates the coolant 22 flow from the permanent magnet motor 14 to the air screw compressor 18. After lubricating and cooling the air screw compressor 18, the coolant 22 is cooled, filtered and recirculated through the system 10 following the coolant communication path 20.

The permanent magnet motor 14 includes an adaptor plate 92 having a shaft opening 96 through which the rotor shaft portion 60 extends. Near the shaft opening 96, adaptor plate 92 is increased in thickness relative to the outer perimeter portions of the adaptor plate 92. Increasing the thickness of the adaptor plate 92 near the shaft opening 96 provides a favorable clearance between the cavities within the permanent magnet motor 14 and the air screw compressor 18. Moreover, increasing the thickness of the adaptor plate 92 near the shaft opening 96 provides a favorable ratio between the thickness of the adaptor plate 92 and the diameter of the shaft opening 96.

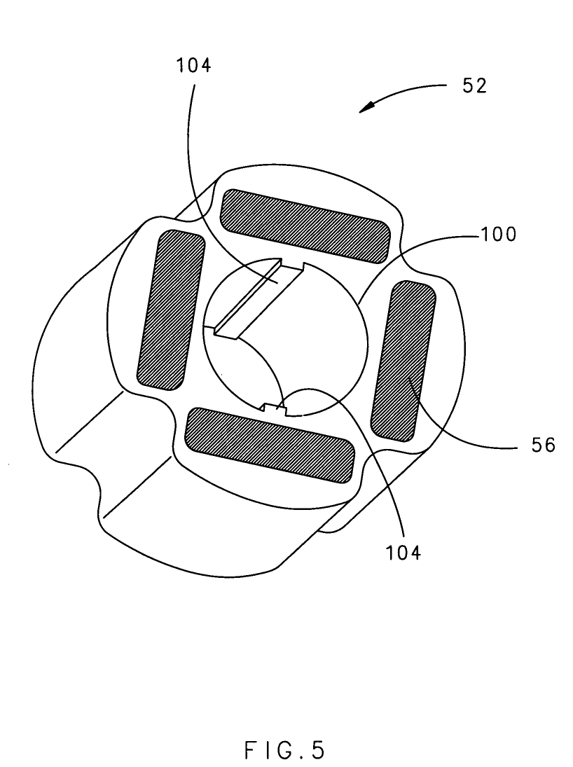

Referring next to FIG. 5, the motor rotor 52 restrains the permanent magnets 56 and is preferably manufactured of multilayered steel stampings. The example motor rotor 52 has general cloverleaf cross-section and defines a rotor opening 100 that engages the rotor shaft portion 60. Keyway features 104 on the motor rotor 52 and corresponding keyway features 104 on the rotor shaft portion 60 ensure that the two parts are locked together. The keyway features 104 prevent relative motion between the motor rotor 52 and shaft portion 60.

Furthermore, maintenance is readily facilitated in that, for example only, if the permanent magnet motor 14 requires replacement, it is readily removed from the air screw compressor 18 and replaced with a different permanent magnet motor 14, without the heretofore necessity of disassembling the air screw compressor 18. Typically, the fastener 54 (FIG. 2) is a locknut, secured to the rotor shaft portion 60, and rotatable about axis 64. Removing the end cover 15 and motor rotor fastener 54 separates motor rotor 52 from the rotor shaft portion 60. Subsequently removing the motor housing 44 and the adaptor plate 92 separates the permanent magnet motor 14 from the air screw compressor 18. The replacement permanent magnet motor 14 then directly mounts to the air screw compressor 18. The rotor opening 100 on the replacement permanent magnet motor 14 engages the rotor shaft portion 60 and is secured by the lock nut 54.

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1) A compressor system, comprising:
an air screw compressor rotor system having a shaft portion; and
a permanent magnet motor directly mounted to said shaft portion for rotation of said air screw compressor rotor therewith.

2) The compressor system as described in claim 1, wherein said air screw compressor rotor includes a male air screw compressor rotor.

3) The compressor system as described in claim 1, wherein said air screw compressor rotor system supports said permanent magnet motor rotor.

4) The compressor system as described in claim 3, wherein a plurality of bearings support said air screw compressor rotor system.

5) The compressor system as described in claim 1, wherein said air screw compressor rotor system includes a female air screw compressor rotor.

6) The compressor system as described in claim 1, wherein said air screw compressor rotor supports said shaft portion and said shaft portion supports said permanent magnet motor rotor.

7) The compressor system as described in claim 1, wherein said permanent magnet motor has a rotor unsupported by said permanent magnet motor.

8) The compressor system as described in claim 1, wherein said air screw compressor system and said permanent magnet motor rotate at a ratio of one revolution to one revolution.

9) The compressor system as described in claim 1, wherein said permanent magnet motor is a sensorless permanent magnet motor.

10) The compressor system as described in claim 1, wherein said permanent magnet motor is lubricant-cooled.

11) The compressor system as described in claim 1, wherein said permanent magnet motor is totally enclosed.

12) A compressor system, comprising:
an air screw compressor system including a compressor rotor having a shaft portion and a rotor portion; and
a permanent magnet motor including a permanent magnet motor rotor, said permanent magnet motor rotor including more than one permanent magnet mounted to said shaft portion, said permanent magnet motor rotor operable to rotate said rotor portion.

13) The compressor system as described in claim 12, wherein said permanent magnet motor rotor defines a rotor opening, which receives said shaft portion.

14) The compressor system as described in claim 13, wherein said shaft portion is releasable from said rotor opening.

15) The compressor system as described in claim 12, wherein said permanent magnet motor further comprises a motor housing and a motor mounting plate, said motor housing said permanent magnet motor rotor and said motor mounting plate mounted directly to said air screw compressor.

16) The compressor system as described in claim 14, wherein said shaft portion extends through said motor mounting plate.

17) The compressor system as described in claim 18, wherein said mounting plate has a first plate thickness and a second plate thickness, said first plate thickness greater than said second plate thickness.

18) The compressor system as described in claim 17, wherein said shaft portion extends through said first plate thickness of said mounting plate.

19) The compressor system as described in claim 12, further comprising a passageway for cooling fluid, wherein said passageway is in communication with both said air screw compressor and said permanent magnet motor.

20) The compressor system as described in claim 12, wherein a cross section of said permanent magnet motor rotor is substantially a cloverleaf shape.

21) The compressor system as described in claim 20, wherein said permanent magnet motor rotor is unsupported by said permanent magnet motor and said permanent magnet motor is supported by said shaft portion.

22) The compressor system as described in claim 12, wherein said permanent magnet motor is a sensorless permanent magnet motor.

23) The compressor system as described in claim 12, wherein said permanent magnet motor is totally enclosed.
